(19) United States
(12) Patent Application Publication
(10) Pub. No.: US 2023/0131884 A1
(43) Pub. Date: Apr. 27, 2023

(54) GENERATING AFFINITY GROUPS WITH MULTINOMIAL CLASSIFICATION AND BAYESIAN RANKING

(71) Applicant: AMPERITY, INC., Seattle, WA (US)

(72) Inventors: Andrew LIM, Brooklyn, NY (US); Joseph CHRISTIANSON, Seattle, WA (US); Joyce GORDON, Seattle, WA (US); Nicholas RESNICK, New York, NY (US); Yan YAN, Seattle, WA (US)

(21) Appl. No.: 17/511,946

(22) Filed: Oct. 27, 2021

(51) Int. Cl. G06N 7/00; G06N 20/20

(52) U.S. Cl. CPC G06N 7/005; G06N 20/20

(57) ABSTRACT

The example embodiments are directed toward improvements in generating affinity groups. In an embodiment, a method is disclosed comprising generating probabilities of object interactions for a plurality of users, a given object recommendation ranking for a respective user comprising a ranked list of object attributes; calculating interaction probabilities for each user over a forecasting window; calculating affinity group rankings based on the probabilities of object interactions and the interaction probabilities for each user; and grouping the plurality of users based on the affinity group rankings.

### BACKGROUND

The example embodiments are directed toward predictive modeling and, in particular, to techniques for predicting a set of users likely to interact with an object in the future.

Currently, systems employ various techniques to identify users that are likely to be interested in objects (e.g., real-world merchandise, digital products, advertisements, etc.). For example, some systems utilize collaborative filtering to first predict the interests of users and then identify objects matching those interests. Many techniques, such as collaborative filtering, suffer from scalability problems as the underlying data set increases in size.

### BRIEF SUMMARY

The example embodiments describe systems, devices, methods, and computer-readable media for generating object affinity groups. In an embodiment, a product affinity group comprises a set of ranked users that are likely to interact with (e.g., purchase) a given object or object attribute. In some embodiments, the example embodiments can generate object affinity groups for entire objects or object attributes. In some embodiments, the example embodiments can predict object affinity groups for a predetermined forecasting window (e.g., a fixed amount of time in the future).

In an embodiment, the example embodiments utilize an object recommendation model to generate object affinity groups. Specifically, in some embodiments, the example embodiments utilize a Bayesian ranking approach to leverage object recommendations to generate object affinity groups. Such an approach maintains the internal consistency between object recommendations and affinity groups and shows significant improvement in the prediction performance.

In some embodiments, the embodiments utilize a classifier to generate object recommendations for a given user. In an embodiment, the classifier outputs a ranked list of object attributes that the given user is likely to interact with over a forecasting period. Next, the example embodiments compute the probability of the given user to interact with (e.g., purchase) any object over the same forecasting window. In an embodiment, the example embodiments can compute this probability using a probabilistic model (e.g., a beta-geometric model), which outputs the total number of expected interactions from a given user over the forecasting period. The example embodiments can then divide the total expected number of interactions for a given user by the total number of expected interactions across all users to obtain the probability that a given interaction will be from the given user.

Finally, the example embodiments can multiply the output of the classifier by the predicted number of interactions to obtain the probability that a given user will interact with a given object or object attribute.

More formally, the object recommendations (e.g., as predicted by the classifier) can be represented as the probability Pr(Oᵢ|Uⱼ), the conditional probability a given object (Oᵢ) will be interacted with by a given user (Uⱼ). As discussed, a classifier such as a random forest, can be trained to generate such a probability. Relatedly, Pr (Uⱼ) can represent the probability that any given interaction will be from the user (Uⱼ) and Pr (Oᵢ) can represent the probability that a given interaction will be made for an object or object attribute (Oᵢ). The value of Pr (Oᵢ) is constant for a given affinity group. The probability that a given user (Uⱼ) will interact with a given object or object attribute (Oᵢ) can be represented as the probability Pr(Uⱼ|Oᵢ) which, under Bayes' rule, can be expressed as follows:

$$P r ( {U}_{j} \vert {O}_{i} ) = \frac{Pr ( {O}_{i} \vert {U}_{j} ) P r ( {U}_{j} )}{Pr ( {O}_{i} )} \qquad EQUATION 1$$

Since Pr (Oᵢ) is constant, the ranking of probability Pr(Uⱼ|Oᵢ) which is considered an object or object attribute affinity score, can be simplified to the ranking of Pr(Oᵢ|Uⱼ)Pr(Uⱼ).

### BRIEF DESCRIPTION OF THE DRAWINGS

FIG. 1 is a system diagram illustrating a system for generating affinity groups according to some embodiments.

FIG. 2 is a flow diagram illustrating a method for ranking users based on object affinity according to some of the example embodiments.

FIG. 3 is a flow diagram illustrating a method for generating object recommendations according to some of the example embodiments.

FIG. 4 is a flow diagram illustrating a method for calculating interaction probabilities according to some embodiments of the example embodiments.

FIG. 5 is a flow diagram illustrating a method for calculating affinity group rankings according to some of the example embodiments.

FIG. 6 is a flow diagram illustrating a method for generating a ranked list of users based on affinity group rankings according to some of the example embodiments.

FIG. 7 is a block diagram of a computing device according to some embodiments of the disclosure.

### DETAILED DESCRIPTION

The example embodiments describe systems, devices, methods, and computer-readable media for generating object affinity groups.

In an embodiment, a method is disclosed comprising generating probabilities of object interactions for a plurality of users, a given object recommendation ranking for a respective user comprising a ranked list of object attributes; calculating interaction probabilities for each user over a forecasting window; calculating affinity group rankings based on the probabilities of object interactions given a user and the interaction probabilities for each user; and grouping the plurality of users based on the affinity group rankings.

In an embodiment, generating an object recommendation ranking for a user comprises classifying the user using a classification model. In an embodiment, classifying the user using a classification model comprises classifying the user using a multinomial random forest classifier. In an embodiment, each attribute in the ranked list of object attributes is associated with a corresponding score used to sort the ranked list of object attributes.

In an embodiment, computing a predicted number of interactions for a given user comprises computing a predicted number of interactions using a lifetime value model. In an embodiment, computing the predicted number of interactions using the lifetime value model comprises computing a predicted number of interactions using a beta-geometric model. In an embodiment, computing the predicted number of interactions comprises dividing the output of the beta-geometric model by a total number of expected orders, the quotient representing the predicted number of interactions for the given user.

In an embodiment, calculating affinity group rankings comprises multiplying the object attribute recommendation rankings by the interaction probabilities for each user to obtain a likelihood for each user.

In some embodiments, devices, non-transitory computer-readable storage mediums, and systems are additionally described implementing the methods described above.

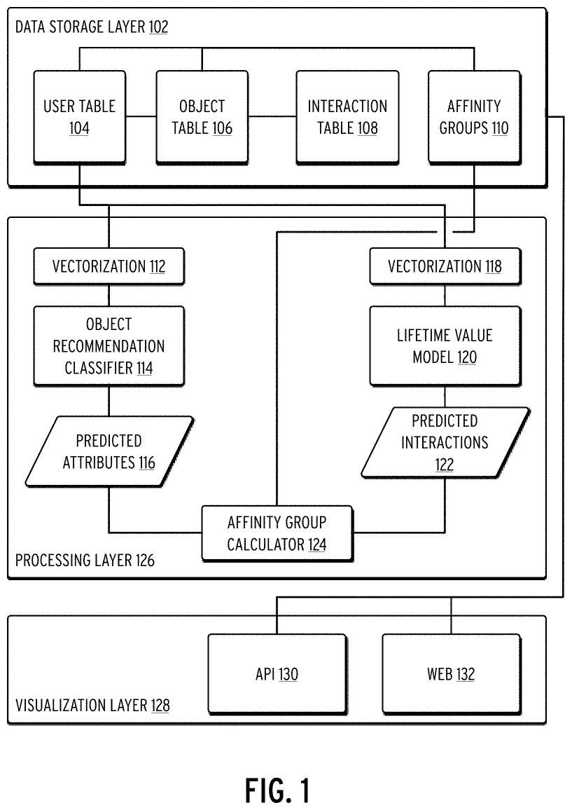

FIG. 1 is a system diagram illustrating a system for generating affinity groups according to some embodiments.

In the illustrated embodiment, the system includes a data storage layer 102. The data storage layer 102 can comprise one or more databases or other storage technologies such as data lake storage technologies or other big data storage technologies. In some embodiments, the data storage layer 102 can comprise a homogenous data layer, that is, a set of homogeneous data storage resources (e.g., databases). In other embodiments, the data storage layer 102 can comprise a heterogeneous data layer comprising multiple types of data storage devices. For example, a heterogeneous data layer can comprise a mixture of relational databases (e.g., MySQL or PostgreSQL databases), key-value data stores (e.g., Redis), NoSQL databases (e.g., MongoDB or CouchDB), or other types of data stores. In general, the type of data storage devices in data storage layer 102 can be selected to best suit the underlying data. For example, user data can be stored in a relational database (e.g., in a table), while interaction data can be stored in a log-structured storage device. Ultimately, in some embodiments, all data may be processed and stored in a single format (e.g., relational). Thus, the following examples are described in terms of relational database tables; however, other techniques can be used.

In the illustrated embodiment, the data storage layer 102 includes a user table 104. The user table 104 can include any data related to users or individuals. For example, user table 104 can include a table describing a user. In some embodiments, the data describing a user can include at least a unique identifier, while the user table 104 can certainly store other types of data such as names, addresses, genders, etc.

In the illustrated embodiment, the data storage layer 102 includes an object table 106. The object table 106 can include details of objects tracked by the system. As one example, object table 106 can include a product table that stores data regarding products, such as unique identifiers of products and attributes of products. As used herein, an attribute refers to any data that describes an object. For example, a product can include attributes describing a brand name, size, color, etc. In some embodiments, attributes can comprise a pair comprising a type and a value. For example, an attribute may include a type (“brand” or “size”) and a value (“Adidas” or “small”). The example embodiments primarily describe operations on attributes or, more specifically, attribute values. However, the example embodiments can equally be applied to the “type” field of the attributes.

In the illustrated embodiment, the data storage layer 102 includes an interaction table 108. The interaction table 108 can comprise a table that tracks data representing interactions between users stored in user table 104 and objects stored in object table 106. In an embodiment, the data representing interactions can comprise fields such as a date of an interaction, a type of interaction, a duration of an interaction, a value of an interaction, etc. One type of interaction can comprise a purchase or order placed by a user stored in user table 104 for an object stored in object table 106. In an embodiment, the interaction table 108 can include foreign key references (or similar structures) to reference a given user stored in user table 104 and a given object stored in object table 106.

In some embodiments, the system can update data in the data storage layer 102 based on interactions detected by monitoring other systems (not illustrated). For example, an e-commerce website can report data to the system, whereby the system persists the data in data storage layer 102. In some embodiments, other systems can directly implement the system themselves. In other embodiments, other systems utilize an application programming interface (API) to provide data to the system.

In the illustrated embodiment, the data storage layer 102 includes an affinity group table 110. In some embodiments, the affinity group table 110 can store a ranked list of users. In one embodiment, the affinity group table 110 can store a ranked list of users for each object or each object attribute, as described in more detail herein.

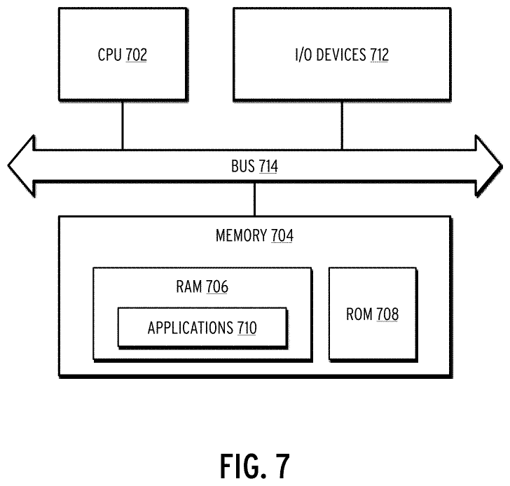

In the illustrated embodiment, the system includes a processing layer 126. In some embodiments, the processing layer 126 can comprise one or more computing devices (e.g., such as that depicted in FIG. 7) executing the methods described herein.

In the illustrated embodiment, the processing layer 126 includes two predictive models: an object recommendation classifier 114 and a lifetime value model 120. In the illustrated embodiment, the outputs of these models (e.g., predicted the probability of objects or object attributes interacted by a given user 116 and predicted the number of interactions 122) are fed to an affinity group calculator 124 that generates affinities groups for (optionally) storing in an affinity group table 110 by multiplying the model outputs together according to the Bayes' Rule.

The object recommendation classifier 114 can comprise a predictive model capable of predicting the likelihood of a given user interacting with either an object or an attribute of an object. For example, object recommendation classifier 114 can predict product attributes that a given user is most interested in. In an embodiment, the object recommendation classifier 114 can comprise a random forest classifier and, in some embodiments, a multinomial random forest classifier.

In the illustrated embodiment, the object recommendation classifier 114 (e.g., multinomial random forest classifier) takes a vector representing a user as an input. In the illustrated embodiment, a first vectorization component 112 is configured to read user data from user table 104 and generate a vector representing a user. In one embodiment, the vector generated by the first vectorization component 112 may comprise an array of values stored in user table 104. However, in an embodiment, the first vectorization component 112 can perform additional processing on the user data prior to generating the vector (for example, word embeddings can be used to vectorize text string). In some embodiments, the vector generated by first vectorization component 112 can include data other than user data. For example, object and interaction data can be included in the resulting vector, as retrieved from object table 106 and interaction table 108, respectively. As one example, a list of interaction dates can be included in the vector, and corresponding object attributes can be included in the vector.

In an embodiment, the first vectorization component 112 can filter the data used to generate the vector based on a forecasting window. For example, if the object recommendation classifier 114 only generates predictions for a fixed time in the future, the first vectorization component 112 may only select a corresponding amount of data in the past. In some embodiments, this corresponding amount of data may comprise an entire data set except a most recent holdout period for validation. In some embodiments, this limiting of input data may be optional and an entire dataset may be used.

In the illustrated embodiment, the object recommendation classifier 114 (e.g., multinomial random forest classifier) outputs a list of object attributes and corresponding scores, referred to as predicted attributes 116. In an embodiment, the corresponding score of a predicted attribute in predicted attributes 116 represents the likelihood of a user interacting (e.g., purchasing) an object having the corresponding attribute. As an example, in e-commerce, the following output may be output by the object recommendation classifier 114:

TABLE 1

| Value | Score |
|---|---|
| shorts | 0.42 |
| shoes | 0.15 |
| jacket | 0.08 |
| . . . | . . . |
| dress | 0.01 |

As illustrated in Table 1, the object recommendation classifier 114 (e.g., multinomial random forest classifier) outputs a probability that a given user will be interested in, and likely interact with, a given object attribute value during a given forecasting window. Formally, the output of object recommendation classifier 114 can be considered as Pr(Oᵢ|Uⱼ), namely the conditional probability a given object (Oᵢ) will be interacted with by a given user (Uⱼ). In some embodiments, the output of object recommendation classifier 114 can be used by a further downstream process (not illustrated) to generate object recommendations. For example, a downstream process can determine that a product including the attributes “jacket,” “dress,” and “shorts” for the user modeled in Table 1 will likely be interacted with during a given forecasting window. In some embodiments, separate classifiers can be trained for each type of attribute (e.g., separate classifiers can be trained for separata taxa such as brand, gender, etc. attributes)

As illustrated, the predicted attributes 116 are provided to an affinity group calculator 124 to generate a plurality of affinity groups for users. In an embodiment, an affinity group can be modeled as recited in Equation 1. To compute this joint probability, the affinity group calculator 124 receives the value of Pr(Oᵢ|Uⱼ) from the predicted attributes 116 and, as will be discussed next, the value of Pr(Uⱼ) from lifetime value model 120.

In the illustrated embodiment, the lifetime value model 120 receives a vector from the second vectorization component 118. In some embodiments, second vectorization component 118 can be similar to or identical to first vectorization component 112, and that detail is not repeated herein.

In the illustrated embodiment, the lifetime value model 120 can comprise a beta-geometric model. For example, in some embodiments, lifetime value model 120 can comprise a shifted beta-geometric (sBG) model. Other similar models may be used such as Pareto/NBD (negative binomial distribution) models. In the illustrated embodiment, the lifetime value model 120 outputs the number of predicted interactions 122 for a given user. In an embodiment, the lifetime value model 120 can be run for each user in user table 104. Thus, in some embodiments, the lifetime value model 120 (e.g., beta-geometric model) can divide a given user's predicted number of interactions by the total number of predicted interactions to obtain a quotient representing the probability (Pr(Uⱼ)) of a given interaction being associated with a given user.

In the illustrated embodiment, the affinity group calculator 124 receives, for each user, a set of attributes and corresponding scores as well as the likelihood that a given interaction will be associated with a user. As a simplistic example (using a single attribute), the following data may be provided to affinity group calculator 124 via predicted attributes 116 (i.e., Pr(Oᵢ|Uⱼ) and predicted interactions 122 (i.e., Pr(Uⱼ)).

TABLE 2

| Uⱼ | Attribute | Pr(Oᵢ\|Uⱼ) | Pr(Uⱼ) |
|---|---|---|---|
| 1 | shoes | 0.080 | 0.076 |
| 2 | shoes | 0.070 | 0.034 |
| 3 | shoes | 0.014 | 0.078 |
| 4 | shoes | 0.008 | 0.059 |
| 5 | shoes | 0.090 | 0.034 |
| 6 | shoes | 0.030 | 0.012 |
| 7 | shoes | 0.052 | 0.042 |

. . .

| | | | |
|---|---|---|---|
| n | shoes | 0.000 | 0.070 |

Based on this input, the predicted attributes 116 can compute a corresponding affinity group score by multiplying the predicted attribute probability by the predicted interaction probability:

TABLE 3

| | | | | Affinity |
|---|---|---|---|---|
| Uⱼ | Attribute | Pr(Oᵢ\|Uⱼ) | Pr(Uⱼ) | Group Score |
| 1 | shoes | 0.080 | 0.076 | 0.006080 |
| 2 | shoes | 0.070 | 0.034 | 0.002380 |
| 3 | shoes | 0.014 | 0.078 | 0.001092 |
| 4 | shoes | 0.008 | 0.059 | 0.000472 |
| 5 | shoes | 0.090 | 0.050 | 0.004500 |
| 6 | shoes | 0.030 | 0.012 | 0.000360 |
| 7 | shoes | 0.052 | 0.042 | 0.002184 |

. . .

| | | | | |
|---|---|---|---|---|
| n | shoes | 0.000 | 0.070 | 0.000000 |

Next, the affinity group calculator 124 can rank the users for a given affinity group score:

TABLE 4

| | | | | Affinity |
|---|---|---|---|---|
| Uⱼ | Attribute | Pr(Oᵢ\|Uⱼ) | Pr(Uⱼ) | Group Score |
| 1 | shoes | 0.080 | 0.076 | 0.006080 |
| 5 | shoes | 0.090 | 0.050 | 0.004500 |
| 2 | shoes | 0.070 | 0.034 | 0.002380 |
| 7 | shoes | 0.052 | 0.042 | 0.002184 |
| 3 | shoes | 0.014 | 0.078 | 0.001092 |
| 4 | shoes | 0.008 | 0.059 | 0.000472 |
| 6 | shoes | 0.030 | 0.012 | 0.000360 |
| n | shoes | 0.000 | 0.070 | 0.000000 |

Based on this ranking, the affinity group calculator 124 can select the top n users and cluster these users to form an affinity group for a given object attribute. As an example, the affinity group calculator 124 can use a probability cut-off (e.g., 0.0020) to cluster users. In this scenario, the top three users (U₁, U₅, U₂) would be selected as the affinity group for the object attribute “shoes.”

Other techniques for clustering can be used. For example, the affinity group calculator 124 can select the top n users where n is defined as a fixed value (e.g., a minimum group size) or a percentage of the total number of users (e.g., the top five percent of users). Certainly, the various approaches may be combined.

In an embodiment, an unsupervised clustering routine can alternatively be employed to automatically cluster users based on the computed affinity group scores. For example, a k-means clustering routine can be employed to automatically cluster users and select a cluster as the affinity group cluster.

In the example above, a single object attribute was used. However, in operation, the affinity group calculator 124 can operate on multiple product attributes. In one embodiment, the affinity group calculator 124 can identify affinity group clusters for each attribute individually. Thus, returning to Table 1 as an example, separate affinity groups for “shorts,” “shoes,” “jacket,” and “dress” can be determined.

As illustrated in FIG. 1, the affinity group calculator 124 can write back the results of the affinity group determination to affinity group table 110. In some embodiments, the affinity group table 110 can store an attribute and a corresponding user identifier in a given row. Thus, continuing from Table 3, with a probability cut off of 0.0020, the data written to affinity group table 110 may comprise data for users (U₁, U₅, U₂):

TABLE 4

| | | | Affinity |
|---|---|---|---|
| ID | Attribute | User ID | Group Score |
| 1 | shoes | 1 | 0.006080 |
| 2 | shoes | 5 | 0.004500 |
| 3 | shoes | 2 | 0.002380 |

As illustrated, each row includes an identifier (e.g., a primary key) and the attribute and user identifier of the clustered user. Further, in some embodiments, the affinity group table 110 can store the affinity group score to allow for re-sorting of the users in the affinity group.

In some embodiments, the processing layer 126 can continuously re-execute the above-described operations over time and for each forecasting window. In such an embodiment, the system can continuously update the affinity group table 110 for use by downstream applications.

In the illustrated embodiment, the system includes a visualization layer 128 that can include, for example, an application API 130 and a web interface 132. In the illustrated embodiment, the components of the visualization layer 128 can retrieve affinity group data from the affinity group table 110 (and other data in data storage layer 102) and present the data or visualizations based on the data to end-users (not illustrated). For example, a mobile application or JavaScript front end can access application API 130 to generate local visualization of affinity group data. As another example, web interface 132 can provide web pages built using data retrieved from affinity group table 110 (e.g., in response to end-user requests).

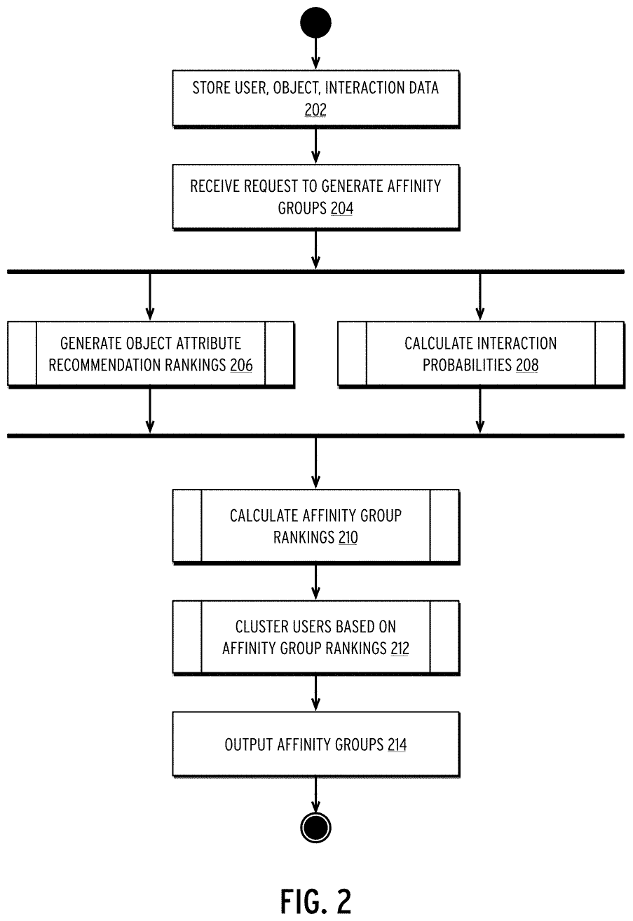

FIG. 2 is a flow diagram illustrating a method for ranking users based on object affinity according to some of the example embodiments.

In step 202, the method comprises storing user, object, and interaction data.

In one embodiment, data regarding users, objects, and interactions can be stored in one or more data stores. For example, users, objects, and interactions can be stored in database tables or similar structures. In some embodiments, the users, objects, and interactions are associated with a single entity or organization. However, in other embodiments, the data stores can further be associated with organizations or entities. In some embodiments, an external data source can provide the users, objects, and interactions, and thus, in step 202, the method can alternatively retrieve or receive the users, objects, and interactions from such an external data source. For example, an entity or organization may store data in its own data store and format. In such an example, the method can ingest this data through a defined interface and store a copy of the raw data in step 202.

In the illustrated embodiment, user data can comprise data related to users or customers of an entity or organization. For example, user data can comprise names, addresses, genders, etc., of users. In the illustrated embodiment, object data can include details of objects such as data regarding products (e.g., unique identifiers of products and attributes of products). In the illustrated embodiment, interaction data can comprise data representing interactions between users and objects. Details of user, object, and interaction were described previously in connection with FIG. 1 and are not repeated herein.

In step 204, the method comprises receiving a request to generate affinity groups.

In the illustrated embodiment, an end-user can issue the request to generate affinity groups. For example, an end-user can issue such requests via an API or web interface, as described in FIG. 1. Alternatively, or in combination with the illustrated embodiment, the method can independently generate affinity groups. In this scenario, the method may not receive an explicit request to generate affinity groups but may rather generate affinity groups according to a predefined schedule (e.g., every 30 days). In one implementation, the predefined schedule can comprise a forecasting window, and in such an implementation, this forecasting window can match the length of the forecasting window that the method generates affinity groups for.

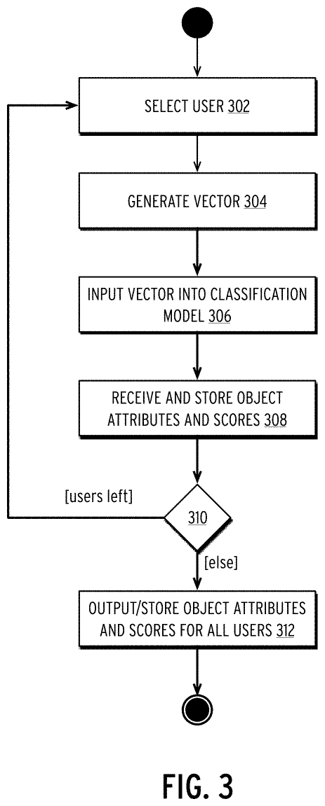

In step 206, the method comprises generating object attribute recommendations. Details of step 206 are described more fully in the description of FIG. 3 and are only briefly summarized here. Reference is made to the description of FIG. 3 for a complete description of step 206.

In some embodiments, the method can generate a vector from the user, object, and interaction data to input into a classification model. In one embodiment, the classification model can comprise a multinomial random forest classifier. The vector can include user data as well interaction/object data. The method can input this vector into the classification model. The classification model can return a set of predicted objects or object attributes that the user is predicted to be interested in interacting with during a preset forecasting window (e.g., 30 days). As used herein, when a classification model returns an entire object, it may return a set of attributes for the object. Thus, the disclosure primarily refers to “attributes” rather than entire objects, although the description should be read to encompass both scenarios.

The classification model can also generate a score for each predicted attribute. In one embodiment, the score can comprise a probability (e.g., a value between zero and one) that the user will interact with a product having a given attribute in the forecasting window. As discussed above, a given attribute to user recommendation can be considered as Pr(Oᵢ|Uⱼ), namely the conditional probability a given object (Oᵢ) will be interacted with by a given user (Uⱼ). In the illustrated embodiment, the method can output a list of attribute-score pairs. In some embodiments, the method can sort the list to generate a ranked list of object attribute values.

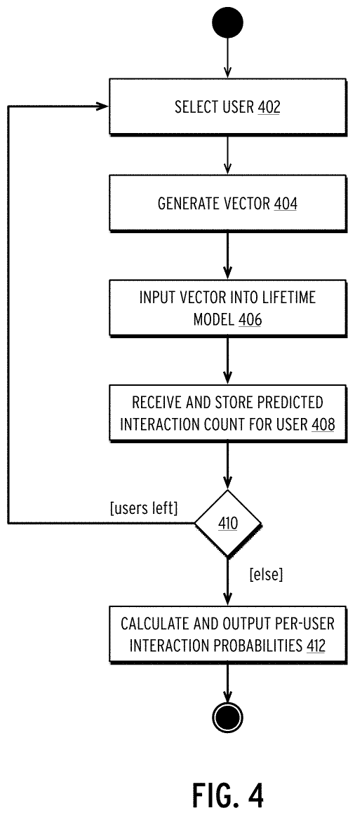

In step 208, the method comprises calculating interaction probabilities for the users. Details of step 208 are described more fully in the description of FIG. 4 and are only briefly summarized here. Reference is made to the description of FIG. 4 for a complete description of step 208.

In brief, the method analyzes each user in the user data to determine the likelihood that any given interaction in the forecasting window will be associated with any given user. In an embodiment, the method inputs a vector into a lifetime value model. In some embodiments, this vector can include user data as well as object or interaction data. The lifetime value model outputs a predicted number of interactions for a given user. The method can perform this per-user calculation of the predicted number of interactions for each user. Then, the method can divide each user's predicted number of interactions by the total number of predicted interactions across all users to obtain a quotient representing an interaction probability (Pr(Uⱼ)) for each user. In some embodiments, the method can use a fast model such as a beta-geometric model to compute the interaction probabilities for each user.

As illustrated, in some embodiments, the method can execute steps 206 and 208 in parallel. In other embodiments, the method can execute steps 206 and 208 in series.

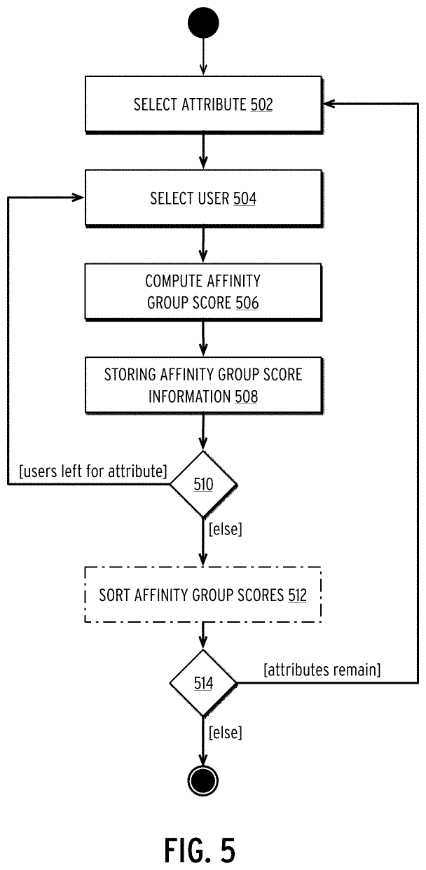

In step 210, the method comprises calculating affinity group rankings. Details of step 210 are described more fully in the description of FIG. 5 and are only briefly summarized here. Reference is made to the description of FIG. 5 for a complete description of step 210.

In brief, after steps 206 and 208, the method obtains, for each user, a set of attributes and scores (Pr(Oᵢ|Uⱼ)) and a likelihood of a given interaction being performed by the user (Pr(Uⱼ)). To compute an affinity group score, the method can comprise multiplying these values together for each attribute per user. Thus, for each user, the method can compute an affinity group score for each attribute predicted for the user.

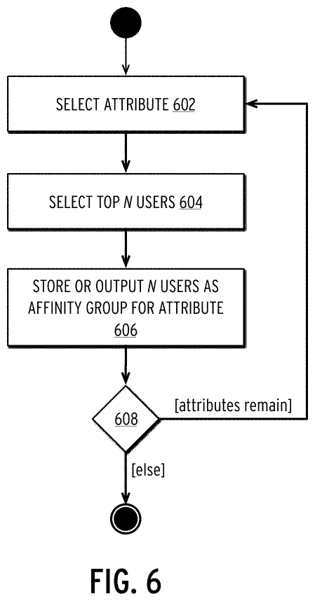

In step 212, the method comprises clustering users based on the affinity group rankings. Details of step 212 are described more fully in the description of FIG. 6 and are only briefly summarized here. Reference is made to the description of FIG. 6 for a complete description of step 212.

In brief, the method can segment the computed affinity group scores based on the attribute. Thus, each attribute is associated with a set of users, each user having a corresponding affinity group score for the respective attribute. In one embodiment, the method can select the top N users, where Nis customizable, and use these top N users as the affinity group cluster for a given attribute. Other clustering techniques, such as unsupervised clustering routines, can be used as discussed previously.

In step 214, the method comprises outputting and/or storing the affinity groups. In one embodiment, the method can store the affinity group clusters in a database table, as described previously in connection with affinity group table 110. Alternatively, or in conjunction with the foregoing, the method can also output the affinity group cluster data to an end-user (e.g., as a report, webpage, API response, etc.).

FIG. 3 is a flow diagram illustrating a method for generating object recommendations according to some of the example embodiments.

In step 302, the method comprises selecting a user. In the illustrated embodiment, the method selects a given user (Uⱼ) from a set of users. In some embodiments, the set of users are stored in a database table, and the method can comprise issuing a query, such as a structured query language (SQL) statement, to the database managing the database table.

In step 304, the method comprises generating a vector. In some embodiments, fields associated with a given user can be used to form a vector. In some embodiments, the method can further retrieve data associated with objects the user has interacted with, as well as interaction data, to generate the vector. As one example, demographic data of a user (e.g., location, gender, etc.) can be combined with tuples representing attributes and interaction dates. Represented in JavaScript Object Notation (JSON), an example of such data is:

```
{
  “user”: { “gender”: “male”, “location”: “New York” },
  “interactions”: [
    {
      “type”: “shoes”,
      “brand”: “adidas”,
      “color”: “blue”,
      “order_date”: “2021-08-05”
    },
    {
      “type”: “dress”,
      “brand”: “jcrew”,
      “color”: “black”,
      “order_date”: “2020-11-22”
    },
  ]
}
```

The specific format of the above JSON object is not limiting. As illustrated, the data includes user demographic data (e.g., gender, location) as well as a list of previous interactions with attributes. Although illustrated in a serialized format (JSON), the vector can be converted into a numerical vector or similar processable format.

In step 306, the method comprises inputting the user vector into a classification model. In one embodiment, the classification model predicts a set of attributes for a given user and a corresponding score representing how likely the user is to interact with a product having the attributes in a forecasting window. For example, in one embodiment, the classification model can comprise a random forest classification model. In a further embodiment, the classification model can comprise a multinomial random forest classification model. Other similar types of classification models can be used, and the use of random forests is not intended to unduly limit the example embodiments.

In step 308, the method comprises receiving and storing object attributes and corresponding scores.

As discussed, the classification model used in step 306 outputs a set of predicted object attributes for a given user and a corresponding score. Each object attribute can comprise an attribute known to the method (e.g., stored in a database of object data). Each corresponding score can comprise a probability (e.g., a value between zero and one) that a user will interact with an attribute during a forecasting window. Thus, in the illustrated embodiment, the output of the classification model comprises a set of probabilities for each object attribute.

In some embodiments, the method can temporarily store these object attribute-score pairs. For example, the method can store the object attribute-score pairs in memory or in a high-speed database such as a key-value store. In some embodiments, the method can use a user identifier as a key, and a dictionary or hash of the object attribute-score pairs as the value in a key-value store. Other storage techniques can be used.

In step 310, the method comprises determining if any users remain to be processed. If the method determines more users remain to be processed, the method returns to step 302 for each remaining user. As illustrated, the method can operate on all available users and thus re-executes steps 302, 304, 306, and 308 for each available user. As such, the method can obtain object attribute-score pairs for each available user.

In step 312, the method comprises outputting object attributes and corresponding scores for the users. In some embodiments, the method outputs the object attributes and corresponding scores for the users to a downstream process (e.g., step 210 of FIG. 2).

FIG. 4 is a flow diagram illustrating a method for calculating interaction probabilities according to some embodiments of the example embodiments.

In step 402, the method comprises selecting a user. In the illustrated embodiment, the method selects a given user (Uⱼ) from a set of users. In some embodiments, the set of users are stored in a database table, and the method can comprise issuing a query, such as an SQL statement, to the database managing the database table.

In step 404, the method comprises generating a vector. In some embodiments, fields associated with a given user can be used to form a vector. In some embodiments, the method can further retrieve data associated with objects the user has interacted with, as well as interaction data, to generate the vector. As one example, demographic data of a user (e.g., location, gender, etc.) can be combined with tuples representing attributes and interaction dates. Details of vector generation were previously described and are not repeated herein.

In step 406, the method comprises inputting the vector into a lifetime model. In one embodiment, the lifetime model predicts the number of interactions a given user will perform within a forecasting window. For example, in one embodiment, the lifetime model can comprise a beta-geometric model such as an sBG model. Other similar types of lifetime models can be used, and the use of beta-geometric models is not intended to unduly limit the example embodiments.

In step 408, the method comprises receiving and storing a predicted interaction count for the user.

As discussed, the lifetime model used in step 406 outputs a number representing the count of expected interactions for a given user in a forecasting window. In some embodiments, the method can temporarily store these user-count pairs. For example, the method can store the user-count pairs in memory or in a high-speed database such as a key-value store. In some embodiments, the method can use a user identifier as a key, and the interaction count as the value in a key-value store. Other storage techniques can be used.

In step 410, the method comprises determining if any users remain to be processed. If the method determines more users remain to be processed, the method returns to step 402 for each remaining user. As illustrated, the method can operate on all available users and thus re-executes steps 402, 404, 406, and 408 for each available user. As such, the method can obtain object user-count pairs for each available user.

In step 412, the method comprises calculating and outputting per-user interaction probabilities for the users.

In the illustrated embodiment, after the method computes user-count pairs for each user, the method can sum or aggregate the count values generated for each user. Next, the method divides each count value associated with a user by the sum or aggregate to obtain a probability that a given interaction will be associated with a given user. In the illustrated embodiment, the method then outputs the per-user probabilities to a downstream process (e.g., step 210 of FIG. 2).

FIG. 5 is a flow diagram illustrating a method for calculating affinity group rankings according to some of the example embodiments.

In step 502, the method comprises selecting an attribute. In one embodiment, the method can select an attribute from a database of attributes. In one embodiment, the database of attributes can comprise attribute fields in a table of objects. As discussed previously, in step 502, the method can obtain all unique values for each attribute. In some embodiments, a type of the attribute can be used to disambiguate attribute values. For example, a “referral source” and “size” attribute type may both include the value “medium” referring to the website and clothing size, respectively. In such a scenario, the type and value may be combined as an attribute (e.g., “size=medium”). In other embodiments, each attribute type can be operated on independently when executing the method of FIG. 5. That is, all unique attribute values of “size” and be fully processed to generate affinity groups before proceeding to process the attribute type “referral source.” As such, the method may not disambiguate in such an implementation.

In step 504, the method comprises selecting a user. In the illustrated embodiment, the method selects a given user (Uⱼ) from a set of users. In some embodiments, the set of users are stored in a database table, and the method can comprise issuing a query, such as an SQL statement, to the database managing the database table.

In step 506, the method comprises computing an affinity group score for the selected user and attribute.

In one embodiment, the method computes an affinity group score for a given user and a given attribute by multiplying the per-user interaction probability output by the method of FIG. 4 with each object attribute score output by the method of FIG. 3.

In step 508, the method comprises storing affinity group score information. In an embodiment, the method can write back each of the affinity group scores to a dedicated data store, such as affinity group table 110, the disclosure of which is not repeated herein. As such, the method generates a series of tuples (user, attribute, affinity group score) for each unique combination of users and attributes.

In step 510, the method determines if any users remain to be processed for the attribute selected in step 502. If so, the method returns to step 504 to process the next user. If not, the method proceeds to step 512. As illustrated, the method can operate on all available users and thus re-executes steps 504, 506, and 508 for each available user.

In step 512, the method sorts the affinity group scores. In some embodiments, step 512 is optional. If implemented, in step 512, the method can select each attribute and sort the generated tuples by affinity group score in, for example, descending order. Note that in some embodiments, sorting may not be necessary if using a database that supports sorting in an efficient manner.

In step 514, the method determines if all attributes have been processed. If not, the method returns to step 502 and re-executes for the next unprocessed attribute. As illustrated, the method can operate on all available users and thus re-executes steps 502, 504, 506, 508, 510, and 512 for each available attribute.

FIG. 6 is a flow diagram illustrating a method for generating a ranked list of users based on affinity group rankings according to some of the example embodiments.

In step 602, the method comprises selecting an attribute. In one embodiment, the method can select an attribute from a database of attributes. In one embodiment, the database of attributes can comprise attribute fields in a table of objects. As discussed previously, in step 502, the method can obtain all unique values for each attribute. In some embodiments, a type of the attribute can be used to disambiguate attribute values. For example, a “referral source” and “size” attribute type may both include the value “medium” referring to the website and clothing size, respectively. In such a scenario, the type and value may be combined as an attribute (e.g., “size=medium”). In other embodiments, each attribute type can be operated on independently when executing the method of FIG. 5. That is, all unique attribute values of “size” and be fully processed to generate affinity groups before proceeding to process the attribute type “referral source.” As such, the method may not disambiguate in such an implementation.

In step 604, the method comprises selecting the top N users for the selected attribute. In one embodiment, the method can sort the users associated with the selected attribute by the affinity group score stored in, for example, the affinity group table. In some embodiments, if the data is pre-sorted, step 604 can be optional.

Other techniques for clustering can be used in step 604. For example, the method can select the top N users where n is defined as a fixed value (e.g., a minimum group size) or a percentage of the total number of users (e.g., the top five percent of users). Certainly, the various approaches may be combined.

In an embodiment, the method can alternatively automatically cluster users based on the computed affinity group scores in step 604. For example, a k-means clustering routine can be employed to automatically cluster users and select a cluster as the affinity group cluster.

In step 606, the method stores or outputs the top N users as the affinity group for the selected attribute. In some embodiments, the method can temporarily store these top N users. For example, the method can store the top N users in memory or in a high-speed database such as a key-value store. Other storage techniques can be used.

In step 608, the method determines if all attributes have been processed. If so, the method ends. If not, the method returns to step 602 and processes the next unprocessed attribute. As illustrated, the method can operate on all available attributes and thus re-executes steps 602 and 604 for each available user.

FIG. 7 is a block diagram of a computing device according to some embodiments of the disclosure. In some embodiments, the computing device can be used to train and use the various ML models described previously.

As illustrated, the device includes a processor or central processing unit (CPU) such as CPU 702 in communication with a memory 704 via a bus 714. The device also includes one or more input/output (I/O) or peripheral devices 712. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 702 may comprise a general-purpose CPU. The CPU 702 may comprise a single-core or multiple-core CPU. The CPU 702 may comprise a system-on-a-chip (SoC) or a similar embedded system. In some embodiments, a graphics processing unit (GPU) may be used in place of, or in combination with, a CPU 702. Memory 704 may comprise a memory system including a dynamic random-access memory (DRAM), static random-access memory (SRAM), Flash (e.g., NAND Flash), or combinations thereof. In one embodiment, the bus 714 may comprise a Peripheral Component Interconnect Express (PCIe) bus. In some embodiments, bus 714 may comprise multiple busses instead of a single bus.

Memory 704 illustrates an example of computer storage media for the storage of information such as computer-readable instructions, data structures, program modules, or other data. Memory 704 can store a basic input/output system (BIOS) in read-only memory (ROM), such as ROM 708, for controlling the low-level operation of the device. The memory can also store an operating system in random-access memory (RAM) for controlling the operation of the device.

Applications 710 may include computer-executable instructions which, when executed by the device, perform any of the methods (or portions of the methods) described previously in the description of the preceding Figures. In some embodiments, the software or programs implementing the method embodiments can be read from a hard disk drive (not illustrated) and temporarily stored in RAM 706 by CPU 702. CPU 702 may then read the software or data from RAM 706, process them, and store them in RAM 706 again.

The device may optionally communicate with a base station (not shown) or directly with another computing device. One or more network interfaces in peripheral devices 712 are sometimes referred to as a transceiver, transceiving device, or network interface card (NIC).

An audio interface in peripheral devices 712 produces and receives audio signals such as the sound of a human voice. For example, an audio interface may be coupled to a speaker and microphone (not shown) to enable telecommunication with others or generate an audio acknowledgment for some action. Displays in peripheral devices 712 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 712 may comprise any input device arranged to receive input from a user. An illuminator in peripheral devices 712 may provide a status indication or provide light. The device can also comprise an input/output interface in peripheral devices 712 for communication with external devices, using communication technologies, such as USB, infrared, Bluetooth®, or the like. A haptic interface in peripheral devices 712 provides tactile feedback to a user of the client device.

A GPS receiver in peripheral devices 712 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 7, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The present disclosure has been described with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein. Example embodiments are provided merely to be illustrative. Likewise, the reasonably broad scope for claimed or covered subject matter is intended. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and,” “or,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, can be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order. For example, two blocks shown in succession can, in fact, be executed substantially concurrently, or the blocks can sometimes be executed in the reverse order, depending upon the functionality/acts involved.

For the purposes of this disclosure, a non-transitory computer-readable medium (or computer-readable storage medium/media) stores computer data, which data can include computer program code (or computer-executable instructions) that is executable by a computer, in machine-readable form. By way of example, and not limitation, a computer-readable medium may comprise computer-readable storage media for tangible or fixed storage of data or communication media for transient interpretation of code-containing signals. Computer-readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer-readable storage media includes, but is not limited to, RAM, ROM, EPROM, EEPROM, flash memory or other solid-state memory technology, CD-ROM, DVD, or other optical storage, cloud storage, magnetic cassettes, magnetic tape, magnetic disk storage, or other magnetic storage devices, or any other physical or material medium which can be used to tangibly store the desired information or data or instructions and which can be accessed by a computer or processor.

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

We claim:

1. A method comprising:
generating probabilities of object interactions for a plurality of users, a given object recommendation ranking for a respective user comprising a ranked list of object attributes;
calculating interaction probabilities for each user over a forecasting window;
calculating affinity group rankings based on the probabilities of object interactions and the interaction probabilities for each user; and
grouping the plurality of users based on the affinity group rankings.

2. The method of claim 1, wherein generating the probability of object interactions for the respective user comprises classifying the respective user using a classification model.

3. The method of claim 2, wherein classifying the respective user using the classification model comprises classifying the respective user using a multinomial random forest classifier.

4. The method of claim 1, wherein each attribute in the ranked list of object attributes is associated with a corresponding score, the corresponding score used to sort the ranked list of object attributes.

5. The method of claim 1, wherein calculating the affinity group rankings comprises computing a predicted number of interactions using a lifetime value model.

6. The method of claim 5, wherein computing the predicted number of interactions using the lifetime value model comprises computing a predicted number of interactions using a beta-geometric model.

7. The method of claim 6, wherein computing the predicted number of interactions comprises dividing an output of the beta-geometric model by a total number of expected interactions to obtain the predicted number of interactions for the respective user.

8. The method of claim 1, wherein calculating affinity group rankings comprises multiplying the probability of object interactions by the interaction probabilities for each user to obtain a likelihood for each user.

9. A non-transitory computer-readable storage medium for tangibly storing computer program instructions capable of being executed by a computer processor, the computer program instructions defining steps of:
generating probabilities of object interactions for a plurality of users, a given object recommendation ranking for a respective user comprising a ranked list of object attributes;
calculating interaction probabilities for each user over a forecasting window;
calculating affinity group rankings based on the probabilities of object interactions and the interaction probabilities for each user; and
grouping the plurality of users based on the affinity group rankings.

10. The non-transitory computer-readable storage medium of claim 9, wherein generating the probabilities of object interactions for the respective user comprises classifying the respective user using a classification model.

11. The non-transitory computer-readable storage medium of claim 10, wherein classifying the respective user using the classification model comprises classifying the respective user using a multinomial random forest classifier.

12. The non-transitory computer-readable storage medium of claim 9, wherein each attribute in the ranked list of object attributes is associated with a corresponding score, the corresponding score used to sort the ranked list of object attributes.

13. The non-transitory computer-readable storage medium of claim 9, wherein calculating the affinity group rankings comprises computing a predicted number of interactions using a lifetime value model.

14. The non-transitory computer-readable storage medium of claim 13, wherein computing the predicted number of interactions using the lifetime value model comprises computing a predicted number of interactions using a beta-geometric model.

15. The non-transitory computer-readable storage medium of claim 14, wherein computing the predicted number of interactions comprises dividing an output of the beta-geometric model by a total number of expected interactions to obtain the predicted number of interactions for the respective user.

16. The non-transitory computer-readable storage medium of claim 9, wherein calculating affinity group rankings comprises multiplying the probabilities of object interactions by the interaction probabilities for each user to obtain a likelihood for each user.

17. A device comprising:
a processor configured to:
generate probabilities of object interactions for a plurality of users, a given object recommendation ranking for a respective user comprising a ranked list of object attributes;
calculate interaction probabilities for each user over a forecasting window;
calculate affinity group rankings based on the probabilities of object interactions and the interaction probabilities for each user; and
group the plurality of users based on the affinity group rankings.

18. The device of claim 17, wherein generating the probabilities of object interactions for the respective user comprises classifying the respective user using a multinomial random forest classifier.

19. The device of claim 17, wherein calculating the affinity group rankings comprises computing a predicted number of interactions using a beta-geometric model.

20. The device of claim 17, wherein calculating affinity group rankings comprises multiplying the probabilities of object interactions by the interaction probabilities for each user to obtain a likelihood for each user.
